(19) United States
(12) Patent Application Publication
(10) Pub. No.: US 2025/0210790 A1
(43) Pub. Date: Jun. 26, 2025

(54) ENERGY STORAGE APPARATUS AND METHOD OF MANUFACTURING ENERGY STORAGE APPARATUS

(71) Applicant: GS Yuasa International Ltd., Kyoto-shi (JP)

(72) Inventors: Ryota MOCHIZUKI, Kyoto-shi (JP); Jun NAKAMURA, Kyoto-shi (JP)

(73) Assignee: GS Yuasa International Ltd., Kyoto-shi (JP)

(21) Appl. No.: 18/847,521

(22) PCT Filed: Mar. 13, 2023
(86) PCT No.: PCT/JP2023/009535

§ 371 Date: Sep. 16, 2024

(30) Foreign Application Priority Data
Mar. 17, 2022 (JP) 2022-042362

(51) Int. Cl. H01M 50/291; H01G 11/10; H01G 11/78; H01M 50/242

(52) U.S. Cl. CPC H01M 50/291; H01G 11/10; H01G 11/78; H01M 50/242

(57) ABSTRACT

An energy storage apparatus 1 includes: an energy storage device 100; a spacer 200c that is arrayed with the energy storage device 100 in a first direction; and a case 300 that includes a case body 310 where an opening 310a is formed on one side in a second direction that is orthogonal to the first direction, the case 300 housing the energy storage device 100 and the spacer 200c, in which the case 300 includes a case wall portion 314 that is disposed in a posture where the case wall portion 314 is directed toward one side in the first direction, the spacer 200c is disposed at a position where the spacer 200c faces the case wall portion 314 and is disposed adjacently to the case wall portion 314, and the case 300 is configured to be brought into contact with the spacer 200c such that a movement of the spacer 200c in at least one direction out of the second direction and a third direction that is orthogonal to the first direction and the second direction is restricted.

### TECHNICAL FIELD

The present invention relates to an energy storage apparatus that includes energy storage devices, spacers and a case, and a method of manufacturing the energy storage apparatus.

### BACKGROUND ART

Conventionally, there has been widely known an energy storage apparatus that includes energy storage devices, spacers disposed adjacently to the energy storage devices, and a case that houses the energy storage devices and the spacers. Patent Document 1 discloses a power supply device (energy storage apparatus) where rectangular battery cells (energy storage devices) and separators (spacers) are housed in an outer case (case).

### PRIOR ART DOCUMENT

### Patent Document

Patent Document 1: JP-A-2012-14962

### SUMMARY OF THE INVENTION

### Problems to be Solved by the Invention

In an energy storage apparatus in which an energy storage device and a spacer are housed in a case, it is desirable to restrict the movement of the energy storage device and the spacer in the case so as to enhance vibration resistance or impact resistance (resistance against vibration or impact from the outside). However, in the energy storage apparatus having the above-mentioned conventional configuration, the energy storage device and the spacer move in the case. Accordingly, there is a concern that vibration resistance or impact resistance cannot be enhanced.

The present invention has made by focusing on the above-described problems from a novel viewpoint, and it is an object of the present invention to provide: an energy storage apparatus that can enhance its vibration resistance or its impact resistance; and a method of manufacturing the energy storage apparatus.

### Means for Solving the Problems

An energy storage apparatus according to an aspect of the present invention includes: an energy storage device; a spacer that is arrayed with the energy storage device in a first direction; and a case that includes a case body where an opening is formed on one side in a second direction that is orthogonal to the first direction, the case housing the energy storage device and the spacer, in which the case includes a case wall portion that is disposed in a posture where the case wall portion is directed toward one side in the first direction, the spacer is disposed at a position where the spacer faces the case wall portion and is disposed adjacently to the case wall portion, and the case is configured to be brought into contact with the spacer such that a movement of the spacer in at least one of the second direction and a third direction that is orthogonal to the first direction and the second direction is restricted.

A method of manufacturing an energy storage apparatus according to an aspect of the present invention is a method of manufacturing an energy storage apparatus that includes: an energy storage device and a spacer positioned adjacently to the energy storage device that are arrayed in a first direction; and a case that includes a case body in which an opening is formed on one side in a second direction that is orthogonal to the first direction and houses the energy storage device and the spacer, in which the method includes: a compressing process of compressing the energy storage device and the spacer in the first direction; an inserting process of inserting the energy storage device and the spacer into the case body in a compressed state, and disposing the spacer at a position such that the spacer faces a case wall portion that the case includes in a posture where the case wall portion is directed toward one side in the first direction and the spacer is disposed adjacently to the case wall portion; and a releasing process of releasing compression of the energy storage device and the spacer such that a spacer protruding portion that the spacer includes and protrudes toward an other side in the first direction is disposed at an other side of a case protruding portion in the second direction, the case protruding portion being included in the case and protruding toward the one side in the first direction.

### ADVANTAGES OF THE INVENTION

According to the energy storage apparatus and the like of the present invention, vibration resistance or impact resistance can be improved.

### BRIEF DESCRIPTION OF THE DRAWINGS

FIG. 1 is a perspective view illustrating the configuration of an energy storage apparatus according to an embodiment 1.

FIG. 2 is an exploded perspective view illustrating energy storage devices and spacers that the energy storage apparatus according to the embodiment includes.

FIG. 3 is a perspective view illustrating the configuration of the energy storage device according to the embodiment.

FIG. 4A is a perspective view illustrating the configuration of the spacer according to the embodiment.

FIG. 4B is a perspective view illustrating the configuration of the spacer according to the embodiment.

FIG. 5 is a perspective view illustrating the configuration of a case body according to the embodiment.

FIG. 6 is a cross-sectional view illustrating the positional relationship between the case body and the spacer according to the embodiment.

FIG. 7A is a perspective view illustrating a compression process in a method of manufacturing the energy storage apparatus according to the embodiment.

FIG. 7B is a perspective view illustrating an insertion process and a releasing process in the method of manufacturing the energy storage apparatus according to the embodiment.

FIG. 8 is a cross-sectional view illustrating the configuration of a case wall portion of a case body and a spacer according to a modification of the embodiment.

### MODE FOR CARRYING OUT THE INVENTION

An energy storage apparatus according to an aspect of the present invention includes: an energy storage device; a spacer that is arrayed with the energy storage device in a first direction; and a case that includes a case body where an opening is formed on one side in a second direction that is orthogonal to the first direction, the case housing the energy storage device and the spacer, in which the case includes a case wall portion that is disposed in a posture where the case wall portion is directed toward one side in the first direction, the spacer is disposed at a position where the spacer faces the case wall portion and is disposed adjacently to the case wall portion, and the case is configured to be brought into contact with the spacer such that a movement of the spacer in at least one of the second direction and a third direction that is orthogonal to the first direction and the second direction is restricted.

With such a configuration, in the energy storage apparatus, the energy storage device and the spacer are housed in the case, and the spacer is disposed adjacently to the case wall portion and hence, the movement of the spacer in at least one direction out of the second direction and the third direction is restricted in the case. As described above, the movement of the spacer disposed adjacently to the case wall portion of the case is restricted and hence, it is possible to restrict the movement of the spacer in the case. With such a configuration, it is possible to restrict a phenomenon that the energy storage device moves together with the spacer and hence, vibration resistance or impact resistance of the energy storage apparatus can be enhanced.

The case may include a case protruding portion that protrudes toward the one side in the first direction, the spacer may include a spacer protruding portion that protrudes toward the other side in the first direction and is disposed on an other side in the second direction of the case protruding portion, and the case may be configured such that the movement of the spacer toward one side in the second direction is restricted due to contacting of the spacer protruding portion with the case protruding portion in the second direction.

With such a configuration, by forming the case protruding portion on the case, by forming the spacer protruding portion on the spacer, and by disposing the spacer protruding portion on the other side in the second direction of the case protruding portion, it is possible to restrict the movement of the case to the one side of the spacer in the second direction. As described above, with the simple configuration where the spacer protruding portion is disposed on the other side of the case protruding portion in the second direction, it is possible to restrict the movement of the spacer in the case to the one side in the second direction. Accordingly, the movement of the energy storage device held by the spacer can be restricted with a simple configuration and hence, it is possible to easily realize the configuration for improving vibration resistance or impact resistance of the energy storage apparatus.

The case may include a plurality of the case protruding portions that are arrayed in the third direction, and the spacer may include a plurality of the spacer protruding portions that are arrayed in the third direction, and the plurality of case protruding portions and the plurality of spacer protruding portions may be brought into contact with each other respectively.

With such a configuration, the case includes the plurality of case protruding portions arrayed in the third direction, the spacers include the plurality of the spacer protruding portions arrayed in the third direction, and the plurality of case protruding portions are brought into contact with the plurality of spacer protruding portions respectively. Accordingly, it is possible to restrict more effectively the movement of the spacer toward one side in the second direction in the case. With such a configuration, it is possible to restrict more effectively a phenomenon that the energy storage device that is held by the spacer moves and hence, vibration resistance or impact resistance of the energy storage apparatus can be enhanced.

At least one of the case protruding portion and the spacer protruding portion may have a shape that is elongated in the second direction.

With such a configuration, at least one of the case protruding portion and the spacer protruding portion is elongated in the second direction and hence, the rigidity in the second direction is increased, whereby it is possible to more firmly restrict the movement of the spacer in the case toward one side in the second direction. Accordingly, it is possible to restrict the movement of the energy storage device held by the spacer more firmly and hence, vibration resistance or impact resistance of the energy storage apparatus can be enhanced.

The case may include: a first case surface that is disposed in a posture where the first case surface is directed toward one side in the third direction; and a second case surface that is disposed in a posture where the second case surface is directed toward the other side in the third direction, the spacer may include: a first spacer surface that faces the first case surface; and a second spacer surface that faces the second case surface, the first case surface may be configured to be brought into contact with the first spacer surface in the third direction such that a movement of the spacer toward the other side in the third direction is restricted, and the second case surface may be configured to be brought into contact with the second spacer surface in the third direction such that a movement of the spacer toward the one side in the third direction is restricted.

With such a configuration, the movement of the spacer toward the other side in the third direction is restricted by bringing the first case surface of the case into contact with the first spacer surface of the spacer, and the movement of the spacer toward the one side in the third direction is restricted by bringing the second case surface of the case into contact with the second spacer surface of the spacer. As a result, it is possible to restrict the movement of the spacer toward both sides in the third direction in the case.

The first spacer surface and the second spacer surface may be disposed at positions such that the first case surface and the second case surface are interposed between the first spacer surface and the second spacer surface in the third direction, or the first case surface and the second case surface may be disposed at positions such that the first spacer surface and the second spacer surface are interposed between the first case surface and the second case surface in the third direction.

With such a configuration, the first spacer surface and the second spacer surface of the spacer interpose the first case surface and the second case surface of the case in the third direction and hence, it is possible to easily suppress the movement of the spacer toward both sides in the third direction in the case. Alternatively, the first case surface and the second case surface of the case interpose the first spacer surface and the second spacer surface of the spacer in the third direction and hence, it is possible to easily suppress the movement of the spacer toward both sides in the third direction in the case.

A method of manufacturing an energy storage apparatus according to an aspect of the present invention is a method of manufacturing an energy storage apparatus that includes: an energy storage device and a spacer positioned adjacently to the energy storage device that are arrayed in a first direction; and a case that include a case body in which an opening is formed on one side in a second direction that is orthogonal to the first direction and houses the energy storage device and the spacer, in which the method includes: a compressing process of compressing the energy storage device and the spacer in the first direction; an inserting process of inserting the energy storage device and the spacer into the case body in a compressed state, and disposing the spacer at a position such that the spacer faces a case wall portion that the case includes in a posture where the case wall portion is directed toward one side in the first direction and the spacer is disposed adjacently to the case wall portion; and a releasing process of releasing compression of the energy storage device and the spacer such that a spacer protruding portion that the spacer includes and that protrudes toward the other side in the first direction is disposed at the other side of a case protruding portion in the second direction, and the case protruding portion being included in the case and protruding toward the one side in the first direction.

With such a configuration, in the method for manufacturing the energy storage apparatus, the energy storage device and the spacer are compressed in the first direction and are inserted into the case body, and the compression of the energy storage device and the spacer is released and hence, the spacer protruding portion of the spacer is disposed on the other side in the second direction of the case protruding portion of the case. With such a configuration, by releasing the compression applied to the energy storage device and the spacer and by arraying the spacer protruding portion on the other side in the second direction of the case protruding portion, it is possible to restrict the movement of the case to the one side in the second direction of the spacer. Accordingly, it is possible to restrict the movement of the energy storage device in the case and hence, it is possible to prevent the occurrence of a phenomenon that the energy storage device is moved together with the spacer and hence, vibration resistance or impact resistance of the energy storage apparatus can be enhanced.

Hereinafter, the energy storage apparatus according to the embodiment of the present invention (including modifications of the embodiment) and the method of manufacturing the energy storage apparatus according to the embodiments of the present invention are described with reference to drawings. All embodiments described hereinafter are comprehensive examples or specific examples of the present invention. Numerical values, shapes, materials, constitutional elements, the array positions and the connection modes of the constitutional elements, manufacturing processes, the order of the manufacturing processes, and the like in the embodiment described hereinafter are provided as an example, and they are not intended to limit the scope of the present invention. In the respective drawings, sizes and the like are not strictly illustrated. In the respective drawings, identical or substantially identical constitutional elements are given the same symbols.

Hereinafter, in the description and in the drawings, an array direction of a pair of electrode terminals that the energy storage device includes, a direction that a pair of short side surfaces of a container of the energy storage device face each other, or the array direction of the energy storage units is defined as an X-axis direction. A direction that a pair of long side surfaces of the container of the energy storage device face each other, a thickness direction (a flat direction) of the container of the energy storage device, an arraying direction of the plurality of energy storage devices that the energy storage unit includes, or a direction along which the energy storage devices and the spacers (holders) that the energy storage unit includes is defined as a Y-axis direction. A protruding direction of the electrode terminals of the energy storage device, an arraying direction of the container body and the container lid of the energy storage device, a direction along which a container body and a container lid portion of the energy storage device are arrayed, a direction along which a case body and a lid body of the case are arrayed, or a direction along which an opening of the case body and a bottom wall of the case body face each other, or a vertical direction is defined as a Z-axis direction. These X-axis direction, Y-axis direction, and Z-axis direction are the directions that intersect with each other (orthogonal to each other in the present embodiments). A case is also considered where the Z-axis direction is not the vertical direction depending on a use mode. However, in the description made hereinafter, for the sake of convenience of the description, the description is made by assuming the Z-axis direction as the vertical direction.

In the description made hereinafter, an X-axis plus direction indicates an arrow direction of the X-axis, and an X-axis minus direction indicates a direction opposite to the X-axis plus direction. In a case where the direction is simply referred to as the X-axis direction, the X-axis direction indicates both or either one of the X-axis plus direction or the X-axis minus direction. In a case where the reference is made with respect to one side in the X direction and the other side in the X direction are referred to, such a side indicates either one of the X-axis plus direction or the X-axis minus direction. The same goes for the Y-axis direction and the Z-axis direction. In the following description, the Y-axis direction is also referred to as a first direction, the Z-axis direction is also referred to as a second direction, and the X-axis direction is also referred to as a third direction. With respect to the expressions that indicate the relative directions or the relative postures such as “parallel” or “orthogonal”, these expressions also include cases where such directions or postures are not considered “parallel” or “orthogonal” in a strict meaning of the terms. The expression that two directions are parallel to each other means not only a state where these two directions are completely parallel to each other but also a state where these two directions are substantially parallel to each other, that is, a state where these two directions are parallel to each other with a slight difference of substantially a few percent. In the description made hereinafter, the expression “insulation” means “electrical insulation”.

### Embodiments

### [1 Description of Energy Storage Apparatus 1

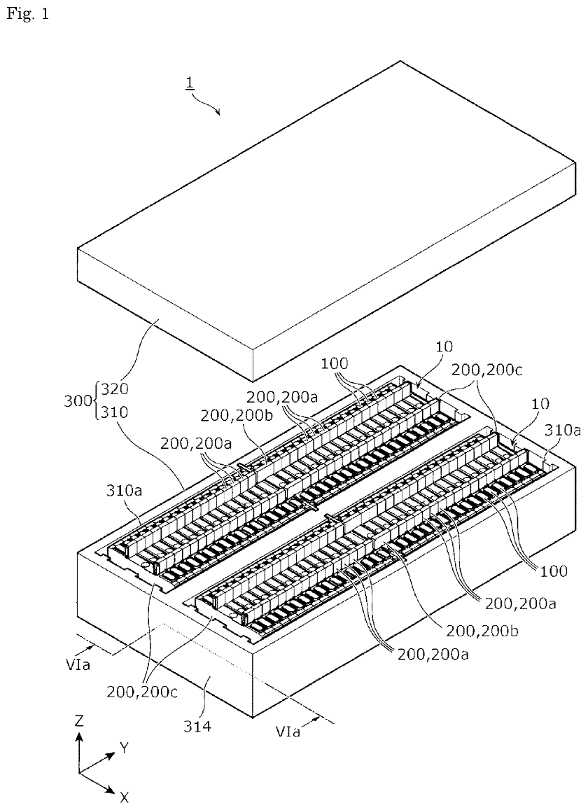

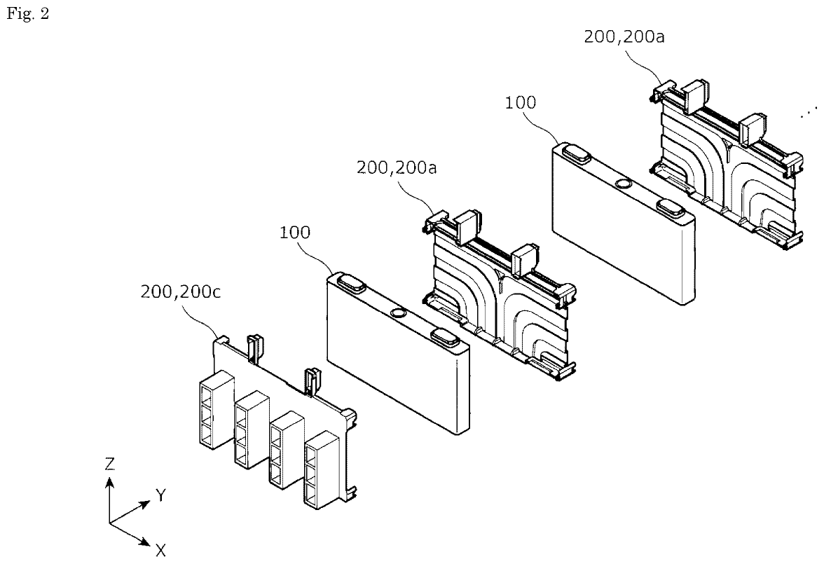

First, the overall configuration of the energy storage apparatus 1 according to the present embodiment is described. FIG. 1 is a perspective view illustrating the configuration of the energy storage apparatus 1 according to the embodiment. FIG. 1 illustrates the energy storage apparatus 1 in a state where a lid body 320 is removed from a case body 310 of a case 300. With such a configuration, in FIG. 1, two energy storage units 10 that are disposed in the case 300 are illustrated. FIG. 2 is an exploded perspective view illustrating energy storage devices 100 and spacers 200 that the energy storage unit 10 of the energy storage apparatus 1 according to the embodiment includes. FIG. 2 illustrates a state where the constitutional elements that the energy storage unit 10 includes are disassembled into two energy storage devices 100 that are positioned on end portions of the energy storage unit 10 in the Y-axis minus direction, and three spacers 200 (two spacers 200a and one spacer 200c). The end portion of the energy storage unit 10 in the Y-axis minus direction, and the end portion of the energy storage unit 10 in the Y-axis plus direction have the same configuration.

The energy storage apparatus 1 is an apparatus capable of charging electricity into the energy storage apparatus 1 from the outside and discharging electricity from the energy storage apparatus 1 to the outside. The energy storage apparatus 1 is used in an electricity storage application, a power source application, or the like. The energy storage apparatus 1 is used as a battery or the like for driving or starting an engine of a moving body such as an automobile, a motorcycle, a watercraft, a ship, a snowmobile, an agricultural machine, a construction machine, or a railway vehicle for an electric railway. As the above-described automobile, an electric vehicle (EV), a hybrid electric vehicle (HEV), a plug-in hybrid electric vehicle (PHEV), and an automobile that uses a fossils fuel (a gasoline, a light oil, a liquefied natural gas or the like) are exemplified. As an example of the railway vehicle for the electric railway described above, a train, a monorail, a linear motor car, and a hybrid train including both a diesel engine and an electric motor are exemplified. The energy storage apparatus 1 can also be used as a stationary battery or the like used as a home-use battery, a business use battery, or the like.

As shown in FIG. 1, the energy storage apparatus 1 includes: an energy storage unit 10; and a case 300 that houses the energy storage unit 10. The energy storage apparatus 1 also includes external terminals (a positive electrode external terminal and a negative electrode external terminal) and the like for electrical connection with an external device. However, the illustration and description of these constituent components are omitted. In addition to the above-described constituent components, the energy storage apparatus 1 may also include a circuit board that monitors or controls a charge state, a discharge state and the like of the energy storage unit 10, and electric equipment such as relays and the like.

The energy storage unit 10 is a battery module (an assembled battery) that includes a plurality of energy storage devices 100. The energy storage unit 10 has a substantially rectangular parallelepiped shape elongated in the Y-axis direction by alternately arraying the plurality of energy storage devices 100 and the spacers 200 in the Y-axis direction (the first direction). In the embodiment, two energy storage units 10 that are arrayed in the X-axis direction are housed in the case 300. The energy storage unit 10 includes: the plurality of energy storage devices 100; and the plurality of spacers 200 (the spacers 200a, 200b and 200c). The energy storage unit 10 also includes: bus bars that connect the energy storage devices 100 in series or in parallel; a bus bar frame that holds the bus bars; and bus bars that connect the energy storage devices 100 and external terminals. However, the illustration of these constituent components is omitted. The bus bars may connect all energy storage devices 100 in series, may connect the energy storage devices 100 in series after connecting some energy storage devices 100 in parallel, or may connect all energy storage devices 100 in parallel.

The energy storage device 100 is a secondary battery (a single battery) capable of charging and discharging electricity, and more specifically, is a nonaqueous electrolyte secondary battery such as a lithium ion secondary battery. The energy storage device 100 has a rectangular parallelepiped shape (a prismatic shape, an angular form) that is flat in the Y-axis direction. In the embodiment, the plurality of energy storage devices 100 are arrayed side by side in the Y-axis direction. However, the number of energy storage devices 100 to be arrayed is not particularly limited, and may be one, several tens, or more. The size and the shape of the energy storage device 100 are also not particularly limited. The shape of the energy storage device 100 may be an elongated circular columnar shape, an elliptical columnar shape, a circular columnar shape, a polygonal columnar shape other than a rectangular parallelepiped shape, or the like. The energy storage device 100 is not limited to a nonaqueous electrolyte secondary battery. The energy storage device 100 may be a secondary battery other than the nonaqueous electrolyte secondary battery, or may be a capacitor. The energy storage device 100 is not necessarily a secondary battery, and may be a primary battery that allows a user to use stored electricity even when the user does not charge the battery. Further, the energy storage device 100 may be a battery that uses a solid electrolyte. The energy storage device 100 may be a pouch-type energy storage device.

The spacer 200 is a member that is flat in the Y-axis direction, is disposed side by side with the energy storage device 100 in the Y-axis direction, and provides electricity insulation and/or heat insulation between the energy storage device 100 and other member. The spacers 200 are electricity insulating plates or heat insulating plates that are disposed in the Y-axis plus direction or in the Y-axis minus direction of the energy storage devices 100, and provide electricity insulation and/or heat insulation between the energy storage devices 100 and between the energy storage devices 100 and the case 300. The spacer 200 is formed of an insulating member made of a material such as polycarbonate (PC), polypropylene (PP), polyethylene (PE), polystyrene (PS), a polyphenylene sulfide resin (PPS), polyphenylene ether (PPE (including modified PPE)), polyethylene terephthalate (PET), polybutylene terephthalate (PBT), polyether ether ketone (PEEK), tetrafluoroethylene/perfluoroalkyl vinyl ether (PFA), polytetrafluoroethylene (PTFE), polyether sulfone (PES), polyamide (PA), an ABS resin, or a composite material of the above-mentioned materials, or a member having heat insulating member such as mica.

The spacer 200 has wall portions on both sides of the energy storage device 100 in the X-axis direction and on both sides of the energy storage device 100 in the Z-axis direction. With such a configuration, the spacer 200 has a function of a spacer that holds the energy storage device 100 and performs positioning of the energy storage device 100. In such a configuration, the spacer 200 disposed at the center position of the energy storage unit 10 in the Y-axis direction (between two energy storage devices 100 disposed at the center position) is referred to as a spacer 200b. The spacers 200 disposed at both ends of the energy storage unit 10 in the Y-axis direction (between the energy storage devices 100 disposed at the ends of the energy storage unit 10 and the case 300) are referred to as spacers 200c. In such a configuration, the spacers 200 disposed between the spacer 200b and the spacer 200c (between two energy storage devices 100 disposed other than the center position) is referred to as a spacer 200a. The spacers 200a, 200b and 200c are alternately arrayed with the energy storage devices 100. FIG. 2 illustrates the configuration where two energy storage devices 100, two spacers 200a, and one spacer 200c are alternately arrayed. However, in a case where other spacers 200a, 200b and 200c are used, these spacers are similarly alternately arrayed with the energy storage devices 100.

To be more specific, as illustrated in FIG. 2, the spacer 200a is an intermediate spacer (an intermediate holder) that holds two energy storage devices 100 disposed on both sides of the spacer 200a in the Y-axis direction. The spacer 200a has wall portions on both sides of two energy storage devices 100 in the X-axis direction, and has wall portions on both sides of two energy storage devices 100 in the Z-axis direction. In the same manner, the spacer 200b is a center plate (a center holder or a center spacer) that holds two energy storage devices 100 disposed on both sides of the spacer 200b in the Y-axis direction. The spacer 200b has wall portions on both sides of two energy storage devices 100 in the X-axis direction, and has wall portions on both sides of two energy storage devices 100 in the Z-axis direction. The spacers 200b have a function of enhancing rigidity of the energy storage unit 10 that is elongated in the Y-axis direction. The spacer 200c is an end spacer (an end holder) that holds one energy storage device 100 disposed on side of the spacer 200c in the Y-axis direction. The spacer 200c has wall portions on both sides of one energy storage device 100 in the X-axis direction, and has wall portions on both sides of such one energy storage device 100 in the Z-axis direction.

The energy storage device 100 that is positioned at the center portion of the energy storage unit 10 in the Y-axis direction is held by the spacer 200a and the spacer 200b. The energy storage device 100 that is positioned at the end portion of the energy storage unit 10 in the Y-axis direction is held by the spacer 200a and the spacer 200c. Each of other energy storage devices 100 is held by two spacers 200a. All spacers 200 (Spacers 200a, 200b and 200c) may be formed of members made of the same material, or some spacers 200 may be formed of members made of a material different from a material of remaining spacers 200.

The case 300 is a container having a substantially rectangular parallelepiped shape (a box shape) which forms an exterior body (an exterior shell) of the energy storage apparatus 1. The case 300 is disposed outside the energy storage unit 10, fixes the energy storage unit 10 at a predetermined position, and protects the energy storage unit 10 from an impact or the like. The case 300 is a metal case formed of a member made of metal such as aluminum, an aluminum alloy, stainless steel, iron, or a plated steel plate. In the embodiment, the case 300 is formed by die-casting aluminum (aluminum die-casting). The case 300 may be formed of a member having insulating property made of a resin material or the like that can be used for forming the spacers 200 that the energy storage unit 10 includes.

As illustrated in FIG. 1, the case 300 includes: a case body 310 that constitutes a body of the case 300; and a lid body 320 that constitutes a lid body of the case 300. The case body 310 is a housing (casing) in which openings 310a are formed in a Z-axis plus direction (one side in a second direction orthogonal to the first direction), and houses the energy storage units 10 (the energy storage devices 100 and the spacers 200 (the spacers 200a, 200b and 200c). The lid body 320 is a flat rectangular member that closes the opening 310a of the case body 310. Two rectangular openings 310a arrayed in the X-axis direction are formed in the case body 310. After the energy storage units 10 are inserted from the respective openings 310a, the case body 310 and the lid body 320 are joined to each other by screwing using bolts or the like, welding, bonding, or the like. With such joining, the case 300 has a structure where the inside of the case 300 is sealed (hermetically sealed). A terminal base for external terminals (a positive electrode external terminal and a negative electrode external terminal) may be mounted on the case body 310 or the lid body 320, and the external terminals may be disposed on the terminal base.

Next, the configurations of the energy storage device 100, the spacers 200 (in particular, the spacer 200c), and the case 300 (in particular, the case body 310) are described in detail.

### [1.1 Description of Energy Storage Device 100]

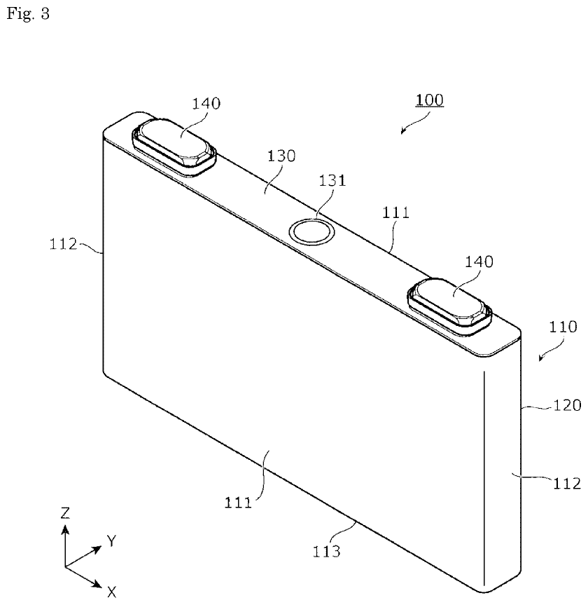

FIG. 3 is a perspective view illustrating the configuration of the energy storage device 100 according to the embodiment. FIG. 3 is an enlarged view illustrating the energy storage device 100 illustrated in FIG. 2. All of the plurality of energy storage devices 100 that the energy storage unit 10 includes have the same configuration. Accordingly, only one energy storage device 100 is illustrated in FIG. 3, and hereinafter, the configuration of one energy storage device 100 is described in detail.

As illustrated in FIG. 3, the energy storage device 100 includes: a container 110; and a pair of electrode terminals 140 (the electrode terminal 140 on a positive electrode side and the electrode terminal 140 on a negative electrode side). In the container 110, an electrode assembly, a pair of current collectors (a current collector on a positive electrode side and a current collector on a negative electrode side), an electrolyte solution (nonaqueous electrolyte) are accommodated. Gaskets are disposed between the electrode terminals 140 and the current collectors, and the container 110. However, these constitutional elements are not illustrated in the drawing. A kind of the electrolyte solution is not particularly limited provided that the performance of the energy storage device 100 is not impaired, and various kinds of electrolyte solutions can be selected. The gaskets may be formed of any material provided that these gaskets have insulating property. The energy storage device 100 may further include, besides the constitutional elements described above, spacers that are disposed on the sides of the electrode assembly, an insulating film that wraps the electrode assembly and the like, an insulating film (a shrink tube or the like) that covers an outer surface of the container 110 and the like.

The container 110 is a case having a rectangular parallelepiped shape (a prismatic shape or a box shape). The container 110 includes: a container body 120 in which an opening is formed; and a container lid portion 130 that closes the opening of the container body 120. The container body 120 is a member that forms a body portion of the container 110 and has a bottomed rectangular cylindrical shape. The opening is formed in the container body 120 on a plus side in the Z-axis direction. The container lid portion 130 is a rectangular plate-like member which forms a lid portion of the container 110 and is elongated in the X-axis direction. The container lid portion 130 is disposed in the Z-axis plus direction of the container body 120. On the container lid portion 130, a gas release valve 131 that releases a pressure in the container 110 when such a pressure becomes excessively large, a solution filling portion (not illustrated in the drawings) through which the container 110 is filled with an electrolyte solution, and the like are mounted. The material of the container 110 (the container body 120 and the container lid portion 130) is not particularly limited. For example, the container 110 may be made of metal that is weldable (joinable) such as stainless steel, aluminum, an aluminum alloy, iron, or a plated steel plate. A resin can be also used as the material of the container 110.

The container 110 has the structure where the inside of the container 110 is sealed. Such sealed structure is obtained by housing the electrode assembly and the like in the container body 120 and, thereafter, by joining the container body 120 and the container lid portion 130 to each other by welding or the like. The container 110 has: a pair of long side surfaces 111 on side surfaces of the container 110 on both sides in the Y-axis direction; a pair of short side surfaces 112 on side surfaces of the container 110 on both sides in the X-axis direction; and a bottom surface 113 on a minus side in the Z-axis direction. The long side surface 111 is a rectangular flat surface portion that forms a long side surface of the container 110, and is disposed so as to face the spacer 200 disposed adjacently to the long side surface 111 in the Y-axis direction. The long side surface 111 is disposed adjacently to a short side surface 112 and a bottom surface 113, and has a larger area than the short side surface 112. The short side surfaces 112 are rectangular flat surface portions that form short side surfaces of the container 110, and are disposed so as to face the wall portions of the spacers 200 and the case 300 in the X-axis direction. The short side surfaces 112 are disposed adjacently to the long side surfaces 111 and the bottom surface 113, and the short side surface 112 has a smaller area than the long side surface 111. The bottom surface 113 is a rectangular flat surface portion forming a bottom surface of the container 110, and is disposed so as to face the wall portion of spacer 200 and the bottom wall of the case 300 in the Z-axis direction. The bottom surface 113 is disposed adjacently to the long side surfaces 111 and the short side surfaces 112.

The electrode terminals 140 are terminal members (a positive electrode terminal and a negative electrode terminal) of the energy storage device 100 disposed on the container lid portion 130. Specifically, the electrode terminals 140 are arrayed in a state where the electrode terminals 140 protrude in the Z-axis plus direction from an upper surface (a terminal array surface) of the container lid portion 130. The electrode terminals 140 are terminals are electrically connected to a positive plate and a negative plate of the electrode assembly via current collectors. The electrode terminals 140 are metal-made members that are provided for discharging electricity stored in the electrode assembly to an external space outside the energy storage device 100, and for charging electricity into an internal space in the energy storage device 100 so as to store electricity in the electrode assembly. The electrode terminals 140 are made of aluminum, an aluminum alloy, copper, a copper alloy, or the like.

The electrode assembly is an energy storage element (a power generating element) formed by stacking a positive electrode plate, a negative electrode plate, and a separator to each other. The positive electrode plate is formed such that a positive active material layer is formed on a positive substrate layer that is a current collecting foil made of metal such as aluminum or an aluminum alloy. The negative electrode plate is formed such that a negative active material layer is formed on a negative substrate layer that is a current collecting foil made of metal such as copper or a copper alloy. As an active material used for forming the positive active material layer and an active material used for forming the negative active material layer, known materials can be appropriately used provided that these materials can occlude and discharge lithium ions. As the separator, a microporous sheet, a nonwoven fabric or the like made of a resin can be used. In the embodiment, the electrode assembly is formed by stacking the plates (the positive plates and the negative plates) in the Y-axis direction. The electrode assembly may be an electrode assembly in any form such as a winding-type electrode assembly formed by winding plates (the positive plate and the negative plate), a layered-type (a stacking-type) electrode assembly formed by stacking a plurality of flat plate-shaped plates, or a bellows-type electrode assembly formed by folding plates in a bellows shape.

The current collectors (the positive electrode current collector and the negative electrode current collector) are members having conductivity that are electrically connected to the electrode terminals 140 and the electrode assembly. The positive electrode current collector is made of aluminum, an aluminum alloy or the like substantially in the same manner as the positive substrate layer of the positive plate of the electrode assembly. The negative electrode current collector is made of copper, a copper alloy, or the like substantially in the same manner as the negative substrate layer of the negative plate of the electrode assembly.

[1.2 Description of Spacer 200c]

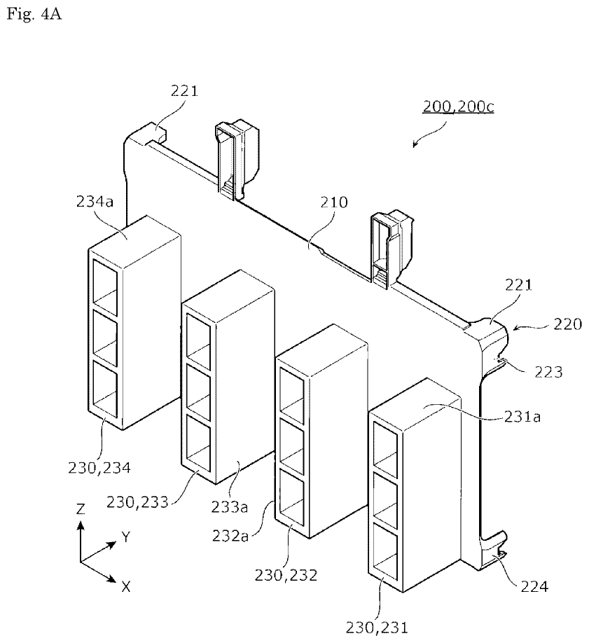

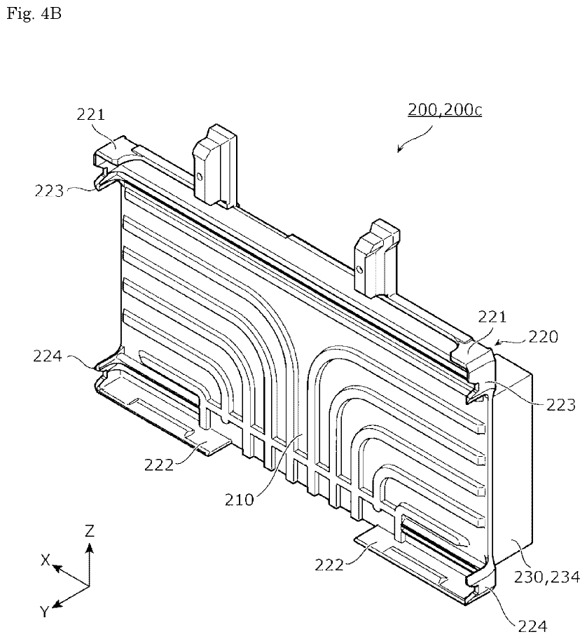

Next, out of the spacers 200, the configuration of the spacer 200c is described in detail. FIG. 4A and FIG. 4B are perspective views illustrating the configuration of the spacer 200c according to the embodiment. Specifically, FIG. 4A shows the spacer 200c illustrated in FIG. 2 in an enlarged manner, and FIG. 4B illustrates the configuration of the spacer 200c in a case where the spacer 200c illustrated in FIG. 4A is rotated by 180° about a line that passes the center of the spacer 200c and is parallel to the Z axis. FIGS. 4A and 4B illustrate the spacer 200c that is positioned at the end of the energy storage unit 10 in the Y-axis minus direction. The spacer 200c that is positioned at the end of the energy storage unit 10 in the Y-axis plus direction has substantially the same configuration as the spacer 200c that is positioned at the end of the energy storage unit 10 in the Y-axis minus direction. Accordingly, hereinafter, the case is described with respect to the spacer 200c that is positioned at the end of the energy storage unit 10 in the Y-axis minus direction.

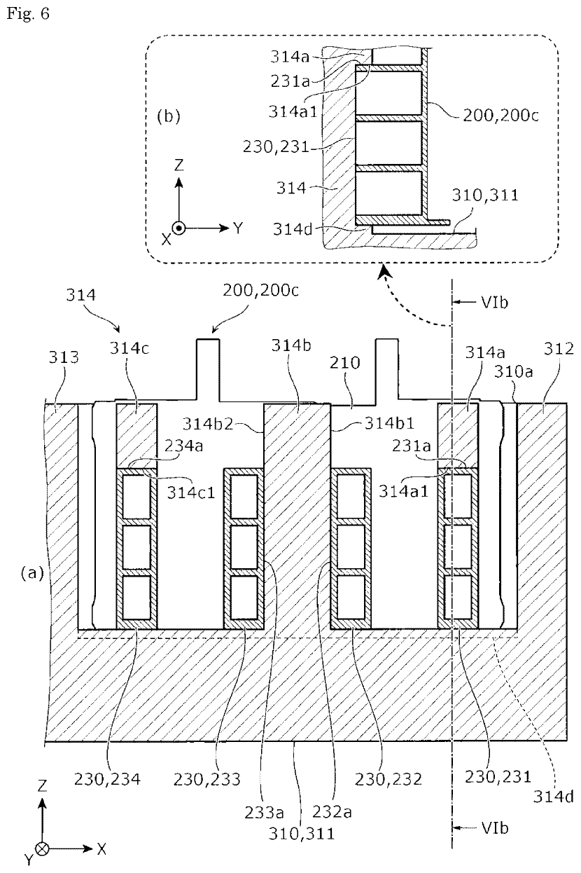

As described above, the spacers 200c are the spacers 200 that are positioned at the end portions of the energy storage unit 10 in the Y-axis direction. The spacer 200c is disposed at a position where the spacer 200c faces a case wall portion 314 (described later) of the case body 310 of the case 300 and disposed adjacently to the case wall portion 314 (see FIG. 1, FIG. 6 and the like). As illustrated in FIG. 4A and FIG. 4B, one half of the spacer 200c in the X-axis plus direction and the other half of the spacer 200c in the X-axis minus direction have the same shape. The spacer 200c has a symmetrical shape with respect to a plane that passes the center position of the spacer 200c and is parallel to a YZ plane. The spacer 200c includes a spacer body 210, spacer wall portions 220, and spacer protruding portions 230.

The spacer body 210 is a portion having a flat plate shape and a rectangular shape that forms a body portion of the spacer 200c. The spacer body 210 is disposed parallel to a XZ plane. The spacer body 210 is disposed at an outer side of the energy storage device 100 in the Y-axis direction (in the case of the spacer 200c illustrated in FIG. 4A and FIG. 4B, in the Y-axis minus direction of the energy storage device 100) where the energy storage device 100 is positioned at the end portion of the energy storage unit 10 in the Y-axis direction. The spacer body 210 is disposed in a state where the spacer body 210 faces the long side surface 111 that the container 110 of the energy storage device 100 has in the Y-axis direction in a state where the spacer body 210 covers the entirety of the long side surface 111 that faces the spacer body 210, and is disposed a state where the spacer body 210 is brought into contact with the long side surface 111.

The spacer wall portions 220 are walls that are disposed on both sides of the spacer wall portion 220 at both sides of the energy storage device 100 in the Z-axis direction and at both sides in the X-axis direction of the energy storage device 100. To be more specific, the spacer wall portion 220 includes: a pair of first spacer wall portions 221 and 222 disposed on both sides of the energy storage device 100 in the Z-axis direction (the second direction); and a pair of second spacer wall portions 223 and a pair of second spacer wall portions 224 disposed on both sides of the energy storage device 100 in the X-axis direction (the third direction orthogonal to the first direction and the second direction).

The first spacer wall portions 221 are flat plate-like portions that protrude in the Y-axis direction from the end portion of the spacer body 210 in the Z-axis plus direction, and are disposed parallel to the XY plane. Specifically, the pair of first spacer wall portions 221 that protrude to one side in the Y-axis direction (the Y-axis plus direction in FIG. 4A and FIG. 4B) from both end portions of the spacer body 210 in the X-axis direction at the end portion of the spacer body 210 in the Z-axis plus direction is disposed at both end portions of the spacer 200c in the X-axis direction. The first spacer wall portions 221 are disposed along the container lid portion 130 of the container 110 of the energy storage device 100 in the Z-axis plus direction of the energy storage device 100. To be more specific, the first spacer wall portions 221 are disposed in such a manner that the first spacer wall portions 221 face the container lid portion 130 in the Z-axis direction so as to cover substantially a half of the container lid portion 130 in the Y-axis direction at both end portions of the energy storage device 100 in the X-axis direction.

The first spacer wall portions 222 are flat plate-like portions that protrude in the Y-axis direction from the end portions of the spacer body 210 in the Z axis minus direction, extend in the X-axis direction, and are disposed parallel to the XY plane. Specifically, the pair of first spacer wall portions 222 that protrudes toward one side in the Y-axis direction (the Y-axis plus direction in FIG. 4A and FIG. 4B) and extends in the X-axis direction is disposed in an extending manner from one end to the other end of the spacer body 210 in the X-axis direction at the end portion of the spacer body 210 in the Z-axis minus direction. The first spacer wall portions 222 are disposed along the bottom surface 113 of the container 110 of the energy storage device 100 in the Z-axis minus direction of the energy storage device 100. To be more specific, the first spacer wall portions 222 are disposed in an extending manner from one end to the other end of the bottom surface 113 in the X-axis direction in such a manner that the first spacer wall portions 222 face the bottom surface 113 in the Z-axis direction so as to cover substantially a half of the bottom surface 113 in the Y-axis direction.

The second spacer wall portions 223 are flat plate-like portions that protrude in the Y-axis direction from the end portion of the spacer body 210 in the X-axis direction and the end portion of the spacer body in the Z-axis plus direction, and is disposed parallel to the YZ plane. Specifically, the pair of second spacer wall portions 223 that protrude to one side in the Y-axis direction (the Y-axis plus direction in FIG. 4A and FIG. 4B) from both end portions of the spacer body 210 in the X-axis direction at the end portion of the spacer body 210 in the Z-axis plus direction is disposed at both end portions of the spacer 200c in the X-axis direction. The second spacer wall portions 223 are disposed along the short side surfaces 112 of the container 110 of the energy storage device 100. To be more specific, the second spacer wall portions 223 are disposed in such a manner that the second spacer wall portions 223 face the short side surfaces 112 in the X-axis direction so as to cover substantially a half of the short side surface 112 in the Y-axis direction at the end portions of the energy storage device 100 in the Z-axis plus direction disposed at both sides of the energy storage device 100 in the X-axis direction.

The second spacer wall portions 224 are flat plate-like portions that protrude in the Y-axis direction from the end portion of the spacer body 210 in the X-axis direction and the end portion of the spacer body 210 in the Z-axis minus direction, and are disposed parallel to the YZ plane. Specifically, the pair of second spacer wall portions 224 that protrude to one side in the Y-axis direction (the Y-axis plus direction in FIG. 4A and FIG. 4B) from both end portions of the spacer body 210 in the X-axis direction at the end portion of the spacer body 210 in the Z-axis plus direction is disposed at both end portions of the spacer 200c in the X-axis direction. The second spacer wall portions 224 are disposed along the short side surfaces 112 of the container 110 of the energy storage device 100. To be more specific, the second spacer wall portions 224 are disposed in such a manner that the second spacer wall portions 224 face the short side surfaces 112 in the X-axis direction so as to cover substantially a half of the short side surface 112 in the Y-axis direction at the end portions of the energy storage device 100 in the Z-axis minus direction disposed at both sides of the energy storage device 100 in the X-axis direction.

In this manner, the spacer wall portion 220 is disposed so as to cover four corner portions of the energy storage device 100 that are positioned at both end portions of the energy storage device 100 in the Z-axis direction and at both end portions in the X-axis direction of the energy storage device 100. With such a configuration, the spacer 200c holds the energy storage device 100.

The spacer protruding portions 230 are portions that are brought into contact with the case 300 so as to restrict the movement of the spacer 200c in the Z-axis direction (the second direction) and the X-axis direction (the third direction). In the embodiment, four spacer protruding portions 230 that protrude in the Y-axis direction from the spacer body 210 are arrayed side by side at intervals in the X-axis direction. With respect to these four spacer protruding portions 230, these spacer protruding portions 230 arrayed from the spacer protruding portion 230 at the end portion of the spacer body 230 on the X-axis plus direction to the spacer protruding portion 230 at the end portion of the spacer body 230 on the X-axis minus direction are also referred to as a spacer protruding portion 231, a spacer protruding portion 232, a spacer protruding portion 233, and a spacer protruding portion 234 in the order of the array. The respective spacer protruding portions 230 (231 to 234) have the same shape. In FIGS. 4A and 4B, the spacer protruding portions 230 (231 to 234) are protruding portions having a rectangular parallelepiped shape that protrudes in the Y-axis minus direction (the other side in the first direction) from the surface of the spacer body 210 in the Y-axis minus direction and is elongated in the Z-axis direction (the second direction). In each of the spacer protruding portions 230 (231 to 234), three recessed portions where each recessed portion is formed by indenting a surface of the spacer protruding portion 230 in the Y-axis minus direction are arrayed side by side in the Z-axis direction. However, the number of the recessed portions is not limited, and the recessed portions may not be formed.

With such a configuration, each of the spacer protruding portions 230 (231 to 234) has: a pair of planar (flat) and rectangular outer surfaces that is arrayed in a posture where the spacer protruding portion 230 is directed in the X-axis direction; and a pair of planar (flat) and rectangular outer surfaces that is arrayed in a posture where the spacer protruding portion 230 is directed in the Z-axis direction. Among outer surfaces of each of the spacer protruding portions 230, the surface that is disposed parallel to the YZ plane disposed in a posture where the surface is directed in the X-axis minus direction of the spacer protruding portion 232 is referred to as a first spacer surface 232a. The surface of the spacer protruding portion 233 that is disposed parallel to the YZ plane disposed in a posture where the surface is directed in the X-axis plus direction of the spacer protruding portion 233 is referred to as a second spacer surface 233a. The surface of the spacer protruding portion 231 that is disposed parallel to the XY plane disposed in a posture where the surface is directed in the Z-axis plus direction of the spacer protruding portion 231 is referred to as a third spacer surface 231a. The surface of the spacer protruding portion 234 that is disposed parallel to the XY plane disposed in a posture where the surface is directed in the Z-axis plus direction of the spacer protruding portion 234 is referred to as a fourth spacer surface 234a.

The first spacer surface 232a is disposed so as to face a first case surface 314b1 of a case protruding portion 314b (described later) of the case 300, and the first spacer surface 232a is brought into contact with the first case surface 314b1 in the X-axis direction (the third direction). With such a configuration, the movement of the spacer 200c in the X-axis minus direction (the other side in the third direction) is restricted. The second spacer surface 233a is disposed so as to face a second case surface 314b2 of the case protruding portion 314b (described later) of the case 300, and the second spacer surface 233a is brought into contact with the second case surface 314b2 in the X-axis direction the (the third direction). With such a configuration, the movement of the spacer 200c in the X-axis plus direction (one side in the third direction) is restricted. The third spacer surface 231a is disposed so as to face a third case surface 314a1 of the case protruding portion 314a (described later) of the case 300, and the third spacer surface 231a is brought into contact with the third case surface 314a1 in the Z-axis direction the (the second direction). With such a configuration, the movement of the spacer 200c in the Z-axis plus direction (one side in the second direction) is restricted. The fourth spacer surface 234a is disposed so as to face a fourth case surface 314c1 of the case protruding portion 314c (described later) of the case 300, and the fourth spacer surface 234a is brought into contact with the fourth case surface 314c1 in the Z-axis direction the (the second direction). With such a configuration, the movement of the spacer 200c in the Z-axis plus direction (one side in the second direction) is restricted.

### [1.3 Description of Case Body 310]

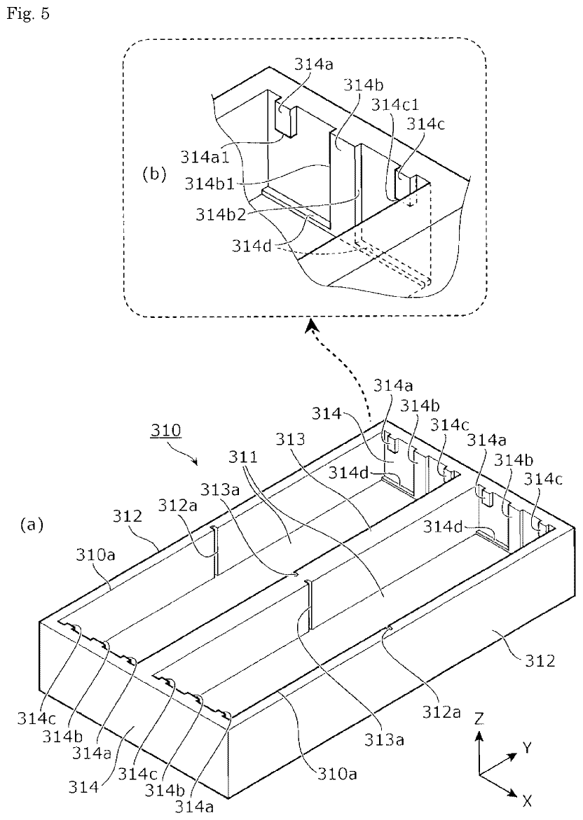

Next, the configuration of the case body 310 that the case 300 includes is described in detail. FIG. 5 is a perspective view illustrating the configuration of the case body 310 according to the embodiment. To be more specific, FIG. 5 (a) is a perspective view illustrating the configuration of the case body 310, and FIG. 5 (b) is a perspective view illustrating the configuration of the end portion of the case body 310 illustrated in FIG. 5 (a) in an X-axis minus direction and in a Y-axis plus direction. FIG. 6 is a cross-sectional view illustrating the positional relationship between the case body 310 and the spacer 200c according to the embodiment. FIG. 6 (a) is a cross-sectional view illustrating the configuration in a case where the spacer protruding portions 230 (231 to 234) of the spacer 200c and the case protruding portions 314a to 314d of the case wall portion 314 of the case body 310 are cut along a plane parallel to the XZ plane (a plane parallel to the XZ plane that passes a line VIa-VIa illustrated in FIG. 1). FIG. 6 (b) is a cross-sectional view illustrating the configuration in a case where the spacer 200c and the case body 310 illustrated in FIG. 6 (a) are cut along a plane parallel to a YZ plane that passes a line VIb-VIb. The half of the case body 310 in the X-axis plus direction and the half of the case body 310 in the X-axis minus direction have substantially the same configuration. Accordingly, FIG. 6 illustrates the half of the case body 310 in the X-axis plus direction, and the description relating to FIG. 6 is made with respect to the half of the case body 310 in the X-axis plus direction.

As illustrated in FIG. 5, the case body 310 includes: a bottom wall 311; and case wall portions 312, 313, and 314. The case body 310 has the bottom wall 311 on a bottom surface portion in the Z-axis minus direction (the other side in the second direction). The case body 310 has the pair of case wall portions 312 at side surface portions on both sides in the X-axis direction. The case body 310 has the case wall portion 313 at a center portion in the X-axis direction. The case body 310 further has the pair of case wall portions 314 at side surface portions on both sides in the Y-axis direction. The case body 310 is formed of one member where the bottom wall 311, two case wall portions 312, the case wall portion 313, and two case wall portions 314 are integrally joined to each other. The case body 310 is integrally formed as one member (one part) by integral molding such as aluminum die casting or the like.

The bottom wall 311 is a flat and rectangular wall portion that is parallel to the XY plane and is elongated in the Y-axis direction. The bottom wall 311 is disposed in a posture where a main surface is directed in the Z-axis direction (the second direction), and forms the bottom surface of the case body 310. The bottom wall 311 is disposed in a state where the bottom wall 311 faces the energy storage unit 10 (the energy storage devices 100 and spacers 200 (spacers 200a, 200b and 200c)) in the Z-axis direction. To be more specific, the bottom wall 311 is disposed in the Z-axis minus direction of the energy storage unit 10 so as to cover the entirety of the surface of the energy storage unit 10. The bottom wall 311 supports the energy storage unit 10 from the Z-axis minus direction. The bottom wall 311 is disposed in a state where the bottom wall 311 is disposed adjacently to the case wall portions 312, 313, and 314.

The case wall portions 312 are flat plate-like rectangular wall portions (side walls) that are parallel to the YZ plane and are elongated in the Y-axis direction. The case wall portions 312 are disposed in a posture where main surfaces of the case wall portions 312 are directed in the X-axis direction (the third direction), and form side surfaces (long side surface) of the case body 310 in the X-axis direction. The case wall portions 312 are wall portions raised in the Z-axis plus direction from an end portion of the bottom wall 311 in the X-axis direction. The case wall portions 312 are disposed so as to face the energy storage unit 10 (the energy storage devices 100 and the spacers 200 (the spacers 200a, 200b and 200c)) in the X-axis direction (the third direction). The case wall portions 312 disposed adjacently to the bottom wall 311 and the case wall portions 314. In the embodiment, two case wall portions 312 are disposed at both end portions of the case body 310 in the X-axis direction in a state where two case wall portions 312 face each other. The case wall portion 312 in the X-axis plus direction is disposed in the X-axis plus direction of the energy storage unit 10 so as to cover the entirety of the surface of the energy storage unit 10 in the X-axis plus direction. The case wall portion 312 in the X-axis minus direction is disposed in the X-axis minus direction of the energy storage unit 10 so as to cover the entirety of the surface of the energy storage unit 10 in the X-axis minus direction.

The case wall portion 313 is a rectangular parallelepiped wall portion that is elongated in the Y-axis direction. The case wall portion 313 is disposed in a posture where main surfaces of the case wall portion 313 are directed in the X-axis direction (the third direction) and partitions a space inside the case body 310. The case wall portion 313 is the wall portion that is raised in the Z-axis plus direction from a center portion of the bottom wall 312 in the X-axis direction. The case wall portion 312 is disposed so as to face the energy storage units 10 (the energy storage devices 100 and the spacers 200 (the spacers 200a, 200b and 200c)) in the X-axis direction (the third direction). To be more specific, the case wall portion 313 is disposed between two energy storage units 10 arrayed in a row in the X-axis direction. The energy storage apparatus 1 includes: the energy storage device 100; and another energy storage device 100 that is housed in the case 300 and is arrayed side by side with the energy storage device 100 in the X-axis direction (the third direction). The case wall portion 313 is the wall disposed between the energy storage device 100 and another energy storage device 100 both being housed in the case 300. With such a configuration, the case wall portion 313 is disposed in the X-axis minus direction of the energy storage unit 10 so as to cover the entirety of the X-axis minus direction side surface of the energy storage unit 10 in the X-axis plus direction. The case wall portion 313 is disposed in the X-axis plus direction of the energy storage unit 10 so as to cover the entirety of the X-axis plus direction side surface of the energy storage unit 10 in the X-axis minus direction. The case wall portion 313 disposed adjacently to the bottom wall 311 and the case wall portions 314.

Recessed portions 312a that extend in the Z-axis direction are formed at the center portion of the case wall portion 312 in the Y-axis direction. One end portions of the spacers 200b in the X-axis direction are inserted into the recessed portions 312a. Recessed portions 313a that extend in the Z-axis direction are formed at the center portion of the case wall portion 313 in the Y-axis direction. The other end portions of the spacers 200b in the X-axis direction are inserted into the recessed portions 313a. The case wall portions 312 and 313 are brought into contact with the spacers 200b and hence, the movement of the spacers 200b in the Y-axis direction (the first direction) is restricted.

The case wall portions 314 are flat plate-shaped rectangular wall portions (side walls) that are parallel to the XZ plane and are elongated in the X-axis direction. The case wall portions 314 are disposed in a posture where main surfaces of the case wall portions 314 are directed in the Y-axis direction (the first direction), and form the side surfaces (the short side surfaces) of the case body 310 in the Y-axis direction. The case wall portions 314 are wall portions raised in the Z-axis plus direction from the end portions of the bottom wall 311 in the Y-axis direction. The case wall portions 314 are disposed so as to face the energy storage unit 10 (the spacers 200c out of the spacers 200) in the Y-axis direction (the first direction). The case wall portions 314 are disposed adjacently to the bottom wall 311, the case wall portions 312 and the case wall portion 313. In the embodiment, two case wall portions 314 are disposed at both end portions of the case body 310 in the Y-axis direction in a state where two case wall portions 314 face each other. The case wall portions 314 in the Y-axis plus direction are disposed in the Y-axis plus direction of the energy storage unit 10 (the spacers 200c) so as to cover the entirety of the surface of the energy storage unit 10 (the spacer 200c in the Y-axis plus direction) in the Y-axis plus direction. The case wall portions 314 in the Y-axis minus direction are disposed in the Y-axis minus direction of the energy storage unit 10 (the spacers 200c) in the Y-axis minus direction so as to cover the entirety of the surface of the energy storage unit 10 (the spacers 200c in the Y-axis minus direction) in the Y-axis minus direction.

With such a configuration, the opening 310a that opens toward the Z-axis plus direction (one side in the second direction) is formed in the case body 310. Two openings 310a that are arrayed in the X-axis direction side by side are formed by two case wall portions 312, the case wall portion 313, and two case wall portions 314. The openings 310a are rectangular openings that are disposed at positions that face the bottom walls 311 of the case body 310, and are elongated in the Y-axis direction as viewed in the Z-axis direction. The openings 310a are disposed at positions that face the energy storage units 10 in the Z-axis direction, and respectively have sizes that allow the energy storage units 10 to pass through the openings 310a in the Z-axis direction. The openings 310a are openings formed in a surface of the case body 310 in the Z-axis plus direction.

The case wall portions 314 are brought into contact with the spacers 200c and hence, it is possible to restrict the movement of the spacers 200c in at least one of the Z-axis direction (the second direction) and the X-axis direction (the third direction). In the embodiment, the case wall portions 314 restrict the movement of the spacers 200c both in the Z-axis direction and in the X-axis direction. To be more specific, the case wall portion 314 has the case protruding portions 314a to 314d, and the case protruding portions 314a to 314d are brought into contact with the spacer protruding portions 230 (231 to 234) of the spacer 200c in the Z-axis direction and in the X-axis direction. Accordingly, it is possible to restrict the movement of the spacer 200c in the Z-axis direction and in the X-axis direction.

The case protruding portions 314a to 314d are protruding portions (protrusions) that are formed on the case wall portion 314 and protrude in the Y-axis direction. The case protruding portions 314a to 314d can be formed by cutting or the like. In the case of the case wall portion 314 in the Y-axis plus direction that is disposed in a posture where the case wall portion 314 faces the Y-axis minus direction, the case protruding portions 314a to 314d are disposed in a protruding manner in the Y-axis minus direction. In the case of the case wall portion 314 in the Y-axis minus direction that is disposed in a posture where the case wall portion 314 faces the Y-axis plus direction (one side in the first direction), the case protruding portions 314a to 314d are disposed in a protruding manner in the Y-axis plus direction.

The case protruding portions 314a and 314c are rectangular parallelepiped protruding portions that are formed on the end portion of the case wall portion 314 in the Z-axis plus direction at both end portions of the case wall portion 314 in the X-axis direction. The case protruding portions 314a and 314c are protruding portions that are flat in the Y-axis direction and are elongated in the Z-axis direction (the second direction). In the case wall portion 314 in the Y-axis plus direction, the case protruding portion 314a is disposed in the X-axis minus direction of the case protruding portion 314b, and the case protruding portion 314c is disposed in the X-axis plus direction of the case protruding portion 314b. In the case wall portion 314 in the Y-axis minus direction, the case protruding portion 314a is disposed in the X-axis plus direction of the case protruding portion 314b, and the case protruding portion 314c is disposed in the X-axis minus direction of the case protruding portion 314b.

The case protruding portions 314b are a rectangular parallelepiped protruding portions which are formed in an extending manner from a Z-axis plus direction end portion to a Z-axis minus direction end portion at a center portion of the case wall portion 314 in the X-axis direction. The case protruding portions 314b are flat in the Y-axis direction, and are elongated in the Z-axis direction (the second direction). The case protruding portion 314d is a rectangular parallelepiped protruding portion which extends in the X-axis direction and is formed from an end portion in the X-axis minus direction to an end portion in the X-axis plus direction at an end portion in the Z-axis minus direction of the case wall portion 314.

The case protruding portion 314b has the first case surface 314b1 and the second case surface 314b2 on outer surfaces on both sides thereof in the X-axis direction. The case protruding portions 314b are formed in a planar shape (a flat shape) and in a rectangular shape parallel to the YZ plane, and extend in the Z-axis direction. In the case wall portion 314 in the Y-axis plus direction, the first case surface 314b1 is disposed in a posture where the first case surface 314b1 is directed in the X-axis minus direction, and the second case surface 314b2 is disposed in a posture where the second case surface 314b2 is directed in the X-axis plus direction (see FIG. 5). In the case wall portion 314 in the Y-axis plus direction, the first case surface 314b1 is disposed in a posture where the first case surface 314b1 is directed in the X-axis plus direction (one side in the third direction), and the second case surface 314b2 is disposed in a posture where the second case surface 314b2 is directed in the X-axis minus direction (the other side in the third direction) (see FIG. 6). The case protruding portion 314a has the third case surface 314a1 on an end surface thereof in the Z-axis minus direction. The third case surface 314a1 has a planar shape (flat shape) parallel to the XY plane and a rectangular shape, and extends in the X-axis direction. The case protruding portion 314c has the fourth case surface 314c1 on an end surface thereof in the Z-axis minus direction. The fourth case surface 314c1 has a planar shape (flat shape) parallel to the XY plane and a rectangular shape, and extends in the X-axis direction.

Hereinafter, the case wall portion 314 in the Y-axis minus direction is described with reference to FIG. 6. As illustrated in FIG. 6, with respect to the case wall portion 314, the spacer protruding portions 232 and 233 of the spacer 200c are brought into contact with the case protruding portion 314b in the X-axis direction (the third direction). Accordingly, the movement of the spacer 200c in the X-axis direction (the third direction) is restricted. Specifically, the spacer protruding portion 232 and the spacer protruding portion 233 are disposed at positions that sandwich the case protruding portion 314b in the X-axis direction (the third direction). The first spacer surface 232a and the second spacer surface 233a are disposed at positions where the first spacer surface 232a and the second spacer surface 233a sandwich the first case surface 314b1 and the second case surface 314b2 in the X-axis direction (the third direction). With such a configuration, the first case surface 314b1 is brought into contact with the first spacer surface 232a in the X-axis direction (the third direction) and hence, the movement of the spacer 200c in the X-axis minus direction (the other side in the third direction) is restricted. The second case surface 314b2 is brought into contact with the second spacer surface 233a in the X-axis direction (the third direction) and hence, the movement of the spacer 200c in the X-axis plus direction (one side in the third direction) is restricted.

In the embodiment, the case protruding portion 314b is press-fitted between the spacer protruding portions 232 and 233 and hence, the spacer protruding portions 232 and 233 and the case protruding portion 314b engage with each other by fitting engagement. The first case surface 314b1 is brought into contact with the first spacer surface 232a in the X-axis direction and hence, the first case surface 314b1 restricts the movement of the spacer 200c in the X-axis minus direction. The first case surface 314b1 may not be brought into contact with the first spacer surface 232a in the X-axis direction. It is sufficient that the first case surface 314b1 be disposed in the vicinity of the first spacer surface 232a in the X-axis direction (allowing the formation of a small gap between the first case surface 314b1 and the first spacer surface 232a). Also in such a configuration, when the spacer 200c slightly moves in the X-axis direction in the first case surface 314b1, the first case surface 314b1 is brought into contact with (brought into a contact state with) the first spacer surface 232a, the movement of the spacer 200c in the X-axis minus direction can be restricted. As described above, it is sufficient that the first case surface 314b1 be configured such that the first case surface 314b1 restricts the movement of the spacer 200c (performs positioning of the spacer 200c) when the first case surface 314b1 is brought into contact with the first spacer surface 232a. The same goes for the second case surface 314b2. The same goes for a case where subsequent movement of the spacer 200c is restricted.

With respect to the case wall portion 314, the spacer protruding portions 231 and 234 of the spacer 200c are brought into contact with the case protruding portions 314a and 314c in the Z-axis direction (the second direction). With such an operation, the movement of the spacer 200c in the Z-axis plus direction (one side in the second direction) is restricted. To be more specific, the spacer protruding portions 231 and 234 are disposed at the Z-axis minus direction side (the other side in the second direction) with respect to the case protruding portions 314a and 314c. The third spacer surface 231a and the fourth spacer surface 234a are disposed in the Z-axis minus direction (the other side in the second direction) with respect to the third case surface 314a1 and the fourth case surface 314c1. With such a configuration, the third case surface 314a1 and the fourth case surface 314c1 are brought into contact with the third spacer surface 231a and the fourth spacer surface 234a in the Z-axis direction (the second direction). Accordingly, the movement of the spacer 200c in the Z-axis plus direction (one side in the second direction) is restricted. As described above, the case 300 and the spacer 200c include a plurality of sets (two sets in the embodiment) of case protruding portions 314a and 314c and spacer protruding portions 231 and 234 arrayed in the X-axis direction (the third direction). In other words, the case 300 has the plurality of case protruding portions 314a and 314c arrayed in the X-axis direction (the third direction), the spacers 200c each have the plurality of spacer protruding portions 231 and 234 arrayed in the third direction, and the plurality of case protruding portions 314a and 314c are brought into contact with the plurality of spacer protruding portions 231 and 234, respectively.

In the embodiment, the case protruding portions 314d are disposed in the Z-axis minus direction of spacer protruding portions 231 to 234 of the spacers 200c. With such a configuration, in the case wall portion 314, the spacer protruding portions 231 to 234 of the spacers 200c are brought into contact with the case protruding portions 314d in the Z-axis direction (the second direction) and hence, the movement of the spacers 200c in the Z-axis minus direction (the other side in the second direction) is also restricted. Specifically, the spacer protruding portions 231 and 234 are press-fitted between the case protruding portions 314a and 314c and the case protruding portions 314d and hence, the case protruding portions 314a, 314c and 314d and the spacer protruding portions 231 and 234 engage with each other by fitting engagement.

### [1.4 Description of Method of Manufacturing Energy Storage Apparatus 1]

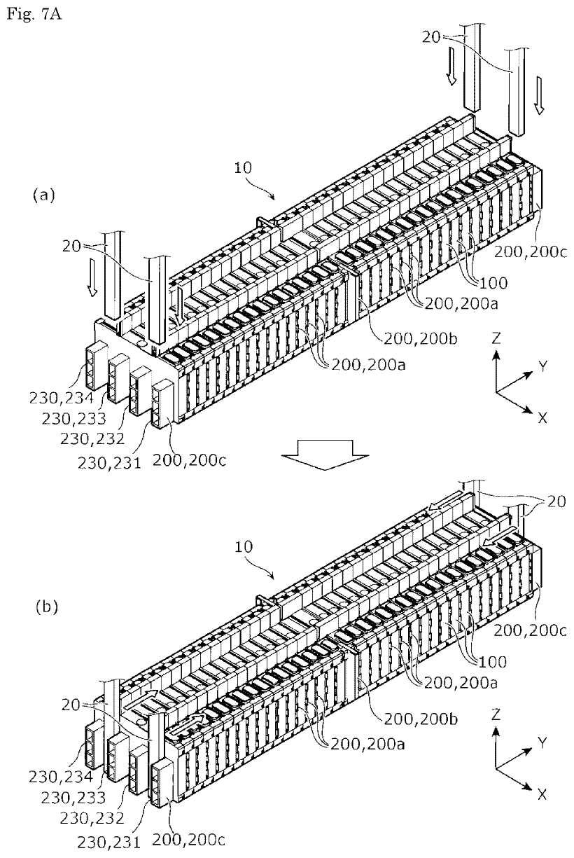

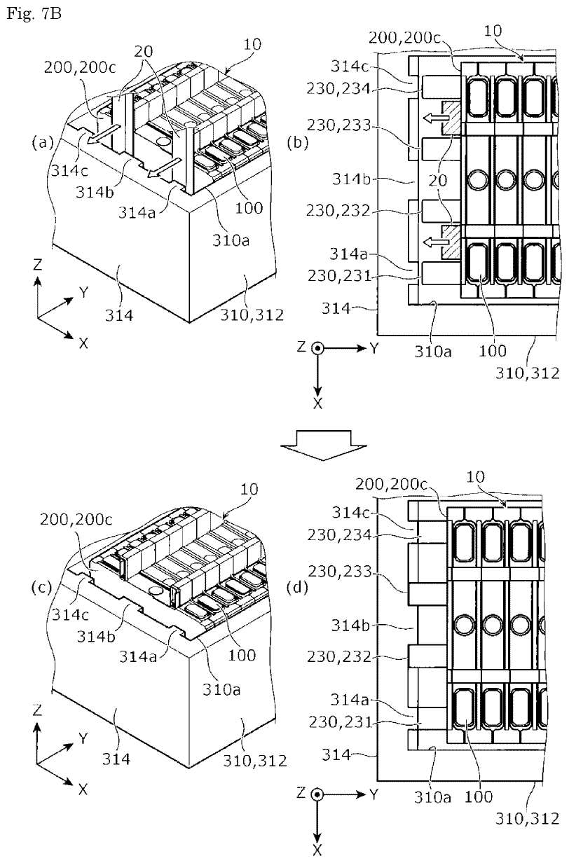

Next, with respect to the method of manufacturing the energy storage apparatus 1, processes of housing the energy storage units 10 in the case 300 (a compressing process, an inserting process and a releasing process) are described in detail. FIG. 7A is a perspective view illustrating a compressing process in a method of manufacturing the energy storage apparatus 1 according to the embodiment. FIG. 7B is a perspective view illustrating an inserting process and a releasing process in the method of manufacturing the energy storage apparatus 1 according to the embodiment. Specifically, FIG. 7B(a) and FIG. 7B(b) are a perspective view and a top plan view illustrating the inserting process, and FIG. 7B(c) and FIG. 7B(d) are a perspective view and a top plan view illustrating the releasing process.

First, as illustrated in FIG. 7A (a), the energy storage unit 10 is formed by stacking the plurality of energy storage devices 100 and the plurality of spacers 200 (the spacers 200a, 200b and 200c) with respect to the spacer 200b. In this state, a pair of jigs 20 is arrayed corresponding to a pair of spacers 200c. In each spacer 200c, the pair of jigs 20 is inserted into a space formed between the spacer protruding portions 231 and 232 of the pair of spacers 200c and into a space formed between the spacer protruding portions 233 and 234.

Next, as illustrated in FIG. 7A(b), the pair of jigs 20 is made to move so as to approach each other in the Y-axis direction with respect to the spacer 200b. As a result, the energy storage unit 10 (the energy storage devices 100, the spacer 200c and the like) is compressed in the Y-axis direction (the first direction) (compressing process). At this stage of the operation, there may be a case where long side surfaces 111 of the energy storage device 100 bulge in the Y-axis direction corresponding to an electrode assembly stored in the energy storage device 100 and an amount and contents of electrolyte solution stored in the energy storage device 100. The spacer 200 is made of a resin, and the spacer 200 may be formed in a compressible shape. For example, the spacer 200a is formed in a corrugated tongue shape, or ribs are formed on the spacer body 210 such that the ribs are formed on the spacer body 210 in a state that the ribs are directed in the Y-axis direction toward the spacer 210c. That is, there may be a case where the spacer 200 is elastically deformable. In the compressing process, the energy storage unit 0 is compressed by a bulging amount of the plurality of energy storage devices 100 that the energy storage unit 10 includes or an elastically deformable amount of the spacers 200. It is sufficient to set a compression amount for compressing the energy storage unit 10 in the Y-axis direction to a value equal to or more than a value of a protruding amount (substantially 5 to 10 mm) in the Y-axis direction of the case protruding portions 314a to 314c that the case wall portion 314 of the case body 310 has.

After the compressing process is finished, as illustrated in FIG. 7B(a) and 7B(b), the energy storage unit 10 (the energy storage devices 100, the spacers 200c and the like) is inserted into the case body 310 in a compressed state (that is, in a state where the energy storage unit 10 is held in a compressed state) (inserting process). In the inserting process, both end portions of the spacer 200b in the X-axis direction and the recessed portions 312a and 313a formed in the case wall portions 312 and 313 of the case body 310 are aligned with each other (not illustrated in the drawings), and the energy storage unit 10 is inserted from the opening 310a formed in the case body 310. In the inserting process, the spacer 200c in the Y-axis minus direction is disposed at the position that faces the case wall portion 314 of the case 300 in the Y-axis minus direction that is disposed in a posture where the case wall portion 314 is directed in the Y-axis plus direction (one side in the first direction) of case 300 and is disposed adjacently to the case wall portion 314. In the same manner, the spacer 200c in the Y-axis plus direction is disposed at a position where the spacer 200c faces the case wall portion 314 of the case 300 in the Y-axis plus direction that is disposed in a posture where the wall portion 314 is directed in the Y-axis minus direction, and the spacer 200c is disposed adjacently to the case wall portion 314.

After the inserting process is finished, as illustrated in FIG. 7B (c) and FIG. 7B (d), the jigs 20 are removed so that the compression applied to the energy storage unit 10 (the energy storage devices 100, the spacers 200c and the like) is released (releasing process). In the releasing process, the bulging of the plurality of compressed energy storage devices 100 or an elastic deformable amount of the spacers 200 returns. Because of a reaction generated by such a return of bulging or the elastic deformation, a compressed state of the energy storage unit 10 is restored and hence, the energy storage unit 10 extends in the Y-axis direction whereby the state is brought about where the energy storage unit 10 is housed in the case body 310. In the releasing process, the spacer protruding portions 231, 234 of the spacer 200c in the Y-axis minus direction that protrude in the Y-axis minus direction (the other side in the first direction) are arrayed in the Z-axis minus direction (the other side in the second direction) of the case protruding portions 314a, 314c of the case wall portions 314 of the case 300 in the Y-axis minus direction that protrude in the Y-axis plus direction (one side in the first direction). In the same manner, the spacer protruding portions 231, 234 of the spacer 200c in the Y-axis plus direction that protrude in the Y-axis plus direction are arrayed in the Z-axis minus direction of the case protruding portions 314a, 314c of the case wall portion 314 of the case 300 in the Y-axis plus direction that protrude in the Y-axis minus direction.

After the inserting process is finished, the case protruding portions 314a, 314c and the spacer protruding portions 231, 234 are arrayed at the positions disposed adjacently to each other in the Y-axis direction as viewed in the Z-axis direction. Accordingly, by performing the releasing process, the spacer protruding portions 231, 234 move in the Y-axis direction, and are arrayed in the Z-axis minus direction of the case protruding portions 314a, 314c. As a result, the spacer protruding portions 231, 234 are press-fitted between the case protruding portions 314a, 314c and the case protruding portion 314d, and hence, case protruding portions 314a, 314c and 314d, and the spacer protruding portions 231 and 234 engage with each other by fitting engagement.

In the releasing process, the spacer protruding portions 232 and 233 that the spacer 200c includes are disposed on both sides (in the X-axis direction) of the case protruding portion 314b that the case wall portion 314 of the case 300 includes. Accordingly, the case protruding portion 314b is press-fitted between the spacer protruding portions 232 and 233 and hence, the spacer protruding portions 232, 233 and the case protruding portion 314b engage with each other by fitting engagement.

Before the energy storage unit 10 is inserted into the case body 310 or after the energy storage unit 10 is inserted into the case body 310, bus bars, a bus bar frame and the like are arrayed on the plurality of energy storage devices 100. Then, the case body 310 and the lid body 320 are joined to each other, the energy storage units 10 are housed in the case 300 so that the energy storage apparatus 1 is manufactured.

### [2 Description of Advantageous Effects]

As described above, according to the energy storage apparatus 1 of the embodiment, the energy storage devices 100 and the spacers 200c are housed in the case 300. The spacers 200c are disposed adjacently to the case wall portions 314 and hence, the case 300 restricts the movement of the spacers 200c in at least one of the second direction (the Z-axis direction) and the third direction (the X-axis direction). In this manner, in the case 300, the movement of the spacers 200c disposed adjacently to the case wall portions 314 is restricted. Accordingly, it is possible to restrict the movement of the spacers 200c in the case 300. With such a configuration, it is possible to restrict the movement of the energy storage device 100 together with the spacers 200c and hence, vibration resistance or impact resistance of the energy storage apparatus 1 can be enhanced.

The case 300 can position the spacers 200c disposed adjacently to the case wall portions 314. Accordingly, the positioning property of the energy storage devices 100 and the spacers 200c can be enhanced when the energy storage devices 100 and the spacers 200c are inserted into the case 300. In particular, the energy storage unit 10 has a long length in the Y-axis direction and hence, it is difficult to position the energy storage unit 10 with respect to the case 300. Accordingly, in this embodiment, the effect of enhancing the positioning property is high. The movement of the spacers 200c in the case 300 can be restricted without providing joining members such as bolts and nuts. Accordingly, a space for arraying the joining members is unnecessary, and a space for arraying tools for joining the joining members are also unnecessary, whereby the energy storage apparatus 1 can realize space saving. The same goes for the configurations described hereinafter.

The case protruding portions 314a, 314c are formed on the case 300, the spacer protruding portions 231, 234 are formed on the spacers 200c, and the spacer protruding portions 231, 234 are disposed on the other side of the case protruding portions 314a, 314c on the other side in the second direction (the Z-axis minus direction). With such a configuration, it is possible to restrict the movement of the case 300 toward one side of the spacer 200c in the second direction (the Z-axis plus direction). In this manner, with the simple configuration where the spacer protruding portions 231, 234 are disposed on the other side of the case protruding portions 314a, 314c in the second direction (Z-axis minus direction), it is possible to restrict to the movement of the spacers 200c in the case 300 toward one side of the spacer 200c in the second direction (Z-axis plus direction). Accordingly, it is possible to restrict the movement of the energy storage device 100 held by the spacers 200c with the simple configuration and hence, the configuration that can enhance vibration resistance or impact resistance of the energy storage apparatus 1 can be easily realized.

The case 300 and the spacers 200c include the plural sets of case protruding portions and the spacer protruding portions (in the embodiment, two sets consisting of the case protruding portions 314a and the spacer protruding portion 231, and the case protruding portion 314c and the spacer protruding portion 234). With such a configuration, it is possible to more effectively restrict the movement of the spacer 200c in the case 300 toward one side (the Z-axis plus direction) in the second direction. In this manner, it is possible to more effectively restrict the movement of the energy storage device 100 held by the spacers 200c and hence, it is possible to enhance vibration resistance and impact resistance of the energy storage apparatus 1.

At least one of the case protruding portions 314a, 314c and the spacer protruding portions 231, 234 (both components in the embodiment) is elongated in the second direction (the Z-axis direction). Accordingly, rigidity in the second direction (the Z-axis direction) is increased and hence, it is possible to more firmly restrict the movement of the spacers 200c in the case 300 toward one side in the second direction (the Z-axis plus direction). Accordingly, it is more firmly restrict the movement of the energy storage device 100 held by the spacer 200c and hence, vibration resistance or impact resistance of the energy storage apparatus 1 can be enhanced.

The first case surface 314b1 of the case 300 is brought into contact with the first spacer surface 232a of the spacer 200c. Accordingly, it is possible to restrict the movement of the spacer 200c toward the other side in the third direction (the X-axis minus direction). The second case surface 314b2 of the case 300 is brought into contact with the second spacer surface 233a of the spacer 200c. Accordingly, it is possible to restrict the movement of the spacer 200c toward one side in the third direction (the X-axis plus direction). Accordingly, it is possible to restrict the movement of the spacer 200c in the case 300 toward both sides in the third direction (X-axis direction).

The first spacer surface 232a and the second spacer surface 233a of the spacer 200c sandwich the first case surface 314b1 and the second case surface 314b2 of the case 300 in the third direction (the X-axis direction). Accordingly, it is possible to easily restrict the movement of the spacer 200c in the case 300 toward both sides in the third direction (X-axis direction).

According to the method of manufacturing the energy storage apparatus 1 according to the embodiment, the energy storage devices 100, the spacers 200 and the like are compressed in the first direction (the Y-axis direction), are inserted into the case body 310, and the compression of the energy storage devices 100, the spacers 200 and the like is released. In such a method, the spacer protruding portions 231, 234 that the spacer 200c includes are arrayed on the other side of the case protruding portions 314a, 314c that the case 300 includes in the second direction (the Z-axis minus direction). In this manner, the compression of the energy storage devices 100 and the spacers 200 is released, and the spacer protruding portions 231, 234 are arrayed at the other side of the case protruding portions 314a, 314c in the second direction (the Z-axis minus direction). Accordingly, it is possible to provide the configuration where the case 300 restricts the movement of the spacer 200c toward one side (Z-axis plus direction) in the second direction. Accordingly, it is possible to restrict the movement of the spacers 200c in the case 300 and hence, it is possible to restrict the movement of the energy storage devices 100 together with the spacers 200c, whereby vibration resistance or impact resistance of the energy storage apparatus 1 can be enhanced.

### [3 Description of Modifications]

The energy storage apparatus 1 according to the embodiment of the present invention has been described heretofore. However, the present invention is not limited to the embodiment described above. The embodiment disclosed this time is illustrative in all aspects, and is not limitative. The present invention includes all alterations which fall within the scope of claims or are considered equivalent to the present invention called for in claims.

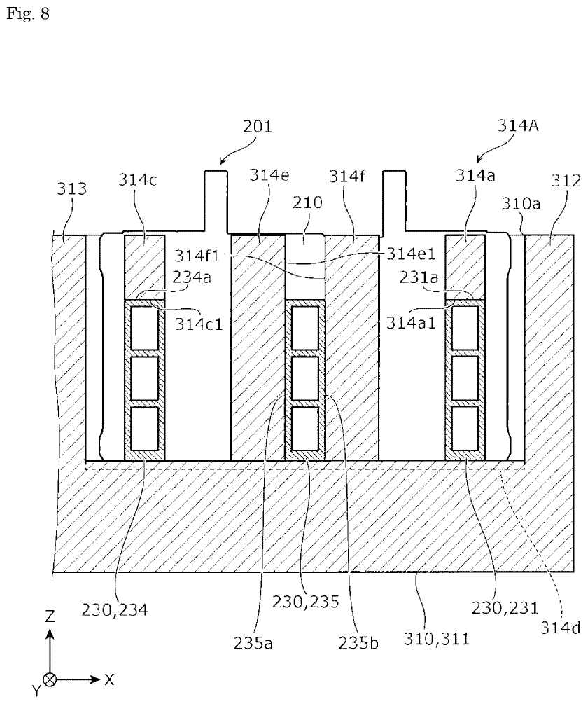

FIG. 8 is a cross-sectional view illustrating the configuration of the case wall portion 314A of the case body 310 and the spacer 201 according to a modification of the embodiment. FIG. 8 is a view corresponding to FIG. 6(a).

As illustrated in FIG. 8, the case wall portion 314A according to the modification includes case protruding portions 314e, 314f in place of the case protruding portion 314b that the case wall portion 314 has in the embodiment described above. The spacer 201 according to the modification includes a spacer protruding portion 235 in place of the spacer protruding portions 232, 233 of the spacer 200c in the embodiment described above. Other configurations of the modification are substantially the same as the corresponding configurations in the embodiment described above and hence, the detailed description of other configurations is omitted.

In the above-mentioned embodiment, the configuration is adopted where the case protruding portion 314b is arrayed (press-fitting, fitting engagement) between the spacer protruding portions 232, 233. However, in the modification, the spacer protruding portion 235 is arrayed (press-fitting, fitting engagement) between the case protruding portions 314e, 314f.

To be more specific, the case protruding portion 314e includes a first case surface 314e1 that is disposed in the X-axis minus direction of the spacer protruding portion 235, and is disposed in a posture that the first case surface 314e1 faces in the X-axis plus direction (one side in the third direction). The case protruding portion 314f includes a second case surface 314f1 that is disposed in the X-axis plus direction of the spacer protruding portion 235, and is disposed in a posture that the second case surface 314f1 faces in the X-axis minus direction (the other side in the third direction). The spacer protruding portion 235 includes: a first spacer surface 235a that is disposed in a state where the first spacer surface 235a faces the first case surface 314e1; and the second spacer surface 235b that is disposed in a state where the second spacer surface 235b faces the second case surface 314f1.

The first case surface 314e1 and the second case surface 314f1 are arrayed at positions that sandwich the first spacer surface 235a and the second spacer surface 235b in the X-axis direction (the third direction). With such a configuration, the first case surface 314e1 is brought into contact with the first spacer surface 235a in the X-axis direction (the third direction) and hence, the movement of the spacer 201 in the X-axis minus direction (the other side in the third direction) is restricted. The second case surface 314f1 is brought into contact with the second spacer surface 235b in the X-axis direction (the third direction) and hence, the movement of the spacer 201 in the X-axis plus direction (one side in the third direction) is restricted.

As described above, the energy storage apparatus 1 according to the modification acquires substantially the same advantageous effect as the energy storage apparatus 1 according to the embodiment described above. Particularly, in the modification, the first case surface 314e1 and the second case surface 314f1 of the case wall portion 314A sandwich the first spacer surface 235a and the second spacer surface 235b of the spacer 201 in the third direction (the X-axis direction). Accordingly, it is possible to easily restrict the movement of the spacer 201 toward both sides in the third direction (the X-axis direction) in the case 300.

### Other Modifications

In the embodiment described above, with respect to the case 300, the case protruding portions 314a to 314d are integrally formed with the case wall portion 314 of the case body 310. However, the case protruding portions 314a to 314d may be formed as separate bodies from the case body 310. In this case, the case protruding portions 314a to 314c that form the separate bodies may be inserted in to the case body 310 after the energy storage unit 10 is inserted into the case body 310. Accordingly, in the method of manufacturing the energy storage apparatus 1, even when the compressing process of compressing the energy storage unit 10 (and the releasing process) is/are not performed, the spacer protruding portions 231, 234 can be disposed in the Z-axis minus direction of the case protruding portions 314a, 314c. The case protruding portions 314a to 314d may be formed on the lid body 320 without forming them on the case body 310.

In the embodiment described above, the first case surface 314b1 of the case 300 is referred to as the surface of the protruding portion (the case protruding portion 314b) formed on the case wall portion 314. However, it is also safe to say that the first case surface 314b1 is a surface of a recessed portion formed on the case wall portion 314. The same substantially goes for other case surfaces. In the same manner, the first spacer surface 232a of the case 300 is referred to as the surface of the protruding portion (the spacer protruding portion 232) formed on the spacer 200c. However, it is also safe to say that the first spacer surface 232a is a surface of a recessed portion formed on the spacer 200c. The same substantially goes for other spacer surfaces. As described above, the present invention is not limited to the case where the movement of the spacer 200c is restricted by contacting of the protruding portion of the case 300 with the protruding portion of the spacer 200c. The movement of the spacer 200c may be restricted by contacting of the protruding portion or the recessed portion of the case 300 with the recessed portion of the spacer 200c, or by contacting of the recessed portion of the case 300 with the protruding portion of the spacer 200c. A stepped portion may be formed on the case 300 or the spacer 200c in place of the protruding portion or the recessed portion.

In the embodiment described above, the array positions and the number of the spacer protruding portions 230 and the array positions and the number of the case protruding portions 314a to 314d are not particularly limited. In the embodiment described above, one case protruding portion 314b is disposed between the spacer protruding portion 232 and the spacer protruding portion 233. However, two case protruding portions 314b may be disposed corresponding to the spacer protruding portion 232 and the spacer protruding portion 233 respectively. Similarly, the other spacer protruding portions 230 and the case protruding portions 314a to 314d each may be divided into a plurality of parts. Either one of the spacer protruding portion 232 or the spacer protruding portion 233 may not be disposed. With respect to the spacer protruding portions and the case protruding portions that are protruding portions arrayed in the Z-axis direction such as the spacer protruding portions 231 and the case protruding portions 314a, one set of protruding portions may be arrayed, or three or more sets of protruding portions may be arrayed.

In the embodiment described above, the case is described where the case protruding portions 314a to 314c of the case 300 and the spacer protruding portions 230 (231 to 234) of the spacer 200c have an elongated shape in the Z-axis direction. However, lengths of these protruding portions in the Z-axis direction are not limited. At least one of the case protruding portions 314a to 314c and the spacer protruding portion 230 may have an elongated shape in the Z-axis direction (the second direction), or neither one of the case protruding portions 314a to 314c nor the spacer protruding portion 230 may have an elongated shape in the Z-axis direction (the second direction).

In the embodiment described above, the case is described where two energy storage units 10 arrayed side by side in the X-axis direction are housed in the case 300. However, three or more energy storage units 10 arrayed side by side in the X-axis direction may be housed in the case 300, or only one energy storage unit 10 may be housed in the case 300. A plurality of energy storage units 10 arrayed side by side in the Y-axis direction may be housed in the case 300. In the case where a plurality of energy storage units 10 are housed in the case 300, the configuration described above may be provided to each of the plurality of energy storage units 10. Alternatively, the configuration described above may not be provided to some of the energy storage units 10.

In the embodiment described above, the case body 310 is configured such that the case body 310 houses the energy storage unit 10 with a sufficient height in the Z-axis direction so as to prevent the energy storage unit 10 from being exposed as viewed from the XY plane. However, this configuration is not indispensable. The case body 310 may have a height that is substantially ⅔ or a half of the height of the energy storage unit 10 in the Z-axis direction so that the case body 310 houses a portion of the energy storage unit 10 in the Z-axis minus direction, and exposes a portion of the energy storage unit 10 in the Z-axis plus direction without housing the portion of the energy storage unit 10 in the Z-axis plus direction. In this case, the lid body 320 may have a height that is substantially ⅓ or a half of the energy storage unit 10 in the Z-axis direction so that the lid body 320 houses the portion of the energy storage unit 10 in the Z-axis plus direction.

In the embodiment described above, the case is described where the spacer 200c includes the pair of first spacer wall portions 221, 222, the pair of second spacer wall portions 223, and the pair of second spacer wall portions 224. However, the present invention is not limited to the case where the spacer 200c includes all of these wall portions. It is sufficient for the spacer 200c to include at least one of these wall portions provided that such a spacer 200c can hold the energy storage device 100.

In the embodiment described above, the case is described where the spacers 200c of all energy storage units 10 have the configuration described above. However, the spacers 200c of some energy storage units 10 may not have the configuration described above.

In the embodiment described above, the case is described where the spacers 200 (the spacers 200a, 200b and 200c) are arrayed side by side alternately with the energy storage devices 100 in the Y-axis direction. However, the configuration may be adopted where some spacers 200 may not be arrayed. The configuration may be adopted where only one pair of spacers 200c is arrayed or only one spacer 200c is arrayed.

In the embodiment described above, the case is described where the case 300 includes the case body 310 and the lid body 320. However, the case 300 may not include the lid body 320. In the embodiment, the case is described where the case 300 is brought into contact with the spacer 200 so as to restrict the movement of the spacer 200 in at least one of the second direction and the third direction that is orthogonal to the first direction and the second direction. However, it may not be always the case that the case 300 is brought into contact with the spacer 200. After the energy storage unit 10 is housed in the case 300, the case 300 and the spacer 200 may be separated from each other or may be brought into a state where these constituent elements are in contact with each other.

In the embodiment described above, the energy storage unit 10 may include constraining members (end plates, side plates and the like) that constrain the plurality of energy storage devices 100 and the spacers 200.

The configurations that are formed by arbitrarily combining the respective constituent elements that the embodiments described above and the modifications of these embodiments include also fall within the scope of the present invention.

### INDUSTRIAL APPLICABILITY

The present invention is applicable to an energy storage apparatus or the like that includes energy storage devices such as lithium ion secondary batteries.

### DESCRIPTION OF REFERENCE SIGNS

1: energy storage apparatus
10: energy storage unit
20: jig
100: energy storage device
110: container
111: long side surface
112: short side surface
113: bottom surface
140: electrode terminal
200: spacer
200a, 200b, 200c, 201: spacer
210: spacer body
220: spacer wall portion
221, 222: first spacer wall portion
223, 224: second spacer wall portion
230, 231, 232, 233, 234, 235: spacer protruding portion
231a: third spacer surface
232a, 235a: first spacer surface
233a, 235b: second spacer surface
234a: fourth spacer surface
300: case
310: case body
310a: opening
311: bottom wall
312, 313, 314, 314A: case wall portion
312a, 313a: recessed portion
314a, 314b, 314c, 314d, 314e, 314f: case protruding portion
314a1: third case surface
314b1, 314e1: first case surface
314b2, 314f1: second case surface
314c1: fourth case surface
320: lid body

1. An energy storage apparatus, comprising:
an energy storage device;
a spacer configured to be arrayed with the energy storage device in a first direction; and
a case comprising a case body having an opening formed on one side of the case body in a second direction orthogonal to the first direction such that the case is configured to house the energy storage device and the spacer in the case body,
wherein the case body of the case includes a case wall portion in the first direction such that the spacer is configured to face the case wall portion and be positioned adjacent to the case wall portion, and the case is configured to be brought into contact with the spacer and restrict a movement of the spacer in at least one of the second direction and a third direction orthogonal to the first direction and the second direction.

2. The energy storage apparatus according to claim 1, wherein the case incudes a case protruding portion protruding in the first direction, and the spacer includes a spacer protruding portion protruding in the first direction and positioned such that the spacer protruding portion is configured to contact the case protruding portion of the case and restrict the movement of the spacer in the second direction.

3. The energy storage apparatus according to claim 2, wherein the case includes the case protruding portion in a plurality such that the plurality of case protruding portions is arrayed in the third direction, and the spacer includes the spacer protruding portion in a plurality such that the plurality of spacer protruding portions is arrayed in the third direction and that the plurality of case protruding portions and the plurality of spacer protruding portions are brought into contact with each other respectively.

4. The energy storage apparatus according to claim 2, wherein at least one of the case protruding portion and the spacer protruding portion has a shape elongated in the second direction.

5. The energy storage apparatus according to claim 1, wherein the case body includes a first case surface in the third direction and a second case surface in the third direction, the spacer includes a first spacer surface configured to face the first case surface of the case body, and a second spacer surface configured to face the second case surface of the case body, the first case surface of the case body is configured to be brought into contact with the first spacer surface of the spacer in the third direction and restrict a movement of the spacer in the third direction, and the second case surface of the case body is configured to be brought into contact with the second spacer surface of the spacer in the third direction and restrict a movement of the spacer in the third direction.

6. The energy storage apparatus according to claim 5, wherein the case body of the case includes the first case surface and the second case surface formed such that the first and second spacer surfaces of the spacer are interposed between the first case surface and the second case surface in the third direction.

7. A method of manufacturing an energy storage apparatus, comprising:
compressing an energy storage device and a spacer positioned adjacent to the energy storage device in a first direction;
inserting the energy storage device and the spacer into a case body of a case in a compressed state such that the spacer faces a case wall portion of the case body and positioned adjacent to the case wall portion; and
releasing compression of the energy storage device and the spacer such that a spacer protruding portion of the spacer protruding in the first direction is positioned on other side in the first direction in a case protruding portion of the case protruding in the first direction,
wherein the case includes the case body having an opening formed on one side in a second direction orthogonal to the first direction and is configured to house the energy storage device and the spacer.

8. The energy storage apparatus according to claim 3, wherein at least one of the case protruding portion and the spacer protruding portion has a shape elongated in the second direction.

9. The energy storage apparatus according to claim 2, wherein the case body includes a first case surface in the third direction and a second case surface in the third direction, the spacer includes a first spacer surface configured to face the first case surface of the case body, and a second spacer surface configured to face the second case surface of the case body, the first case surface of the case body is configured to be brought into contact with the first spacer surface of the spacer in the third direction and restrict a movement of the spacer in the third direction, and the second case surface of the case body is configured to be brought into contact with the second spacer surface of the spacer in the third direction and restrict a movement of the spacer in the third direction.

10. The energy storage apparatus according to claim 9, wherein the case body of the case includes the first case surface and the second case surface formed such that the first and second spacer surfaces of the spacer are interposed between the first case surface and the second case surface in the third direction.

11. The energy storage apparatus according to claim 3, wherein the case body includes a first case surface in the third direction and a second case surface in the third direction, the spacer includes a first spacer surface configured to face the first case surface of the case body, and a second spacer surface configured to face the second case surface of the case body, the first case surface of the case body is configured to be brought into contact with the first spacer surface of the spacer in the third direction and restrict a movement of the spacer in the third direction, and the second case surface of the case body is configured to be brought into contact with the second spacer surface of the spacer in the third direction and restrict a movement of the spacer in the third direction.

12. The energy storage apparatus according to claim 11, wherein the case body of the case includes the first case surface and the second case surface formed such that the first and second spacer surfaces of the spacer are interposed between the first case surface and the second case surface in the third direction.

13. The energy storage apparatus according to claim 11, wherein the case body of the case includes the first case surface and the second case surface formed such that the first case surface and the second case surface are interposed between the first spacer surface of one of the spacers and the second spacer surface of another one of the spacers in the third direction.

14. The energy storage apparatus according to claim 1, wherein the spacer includes a spacer protruding portion protruding in the first direction and positioned such that the spacer protruding portion is configured to restrict the movement of the spacer in the second direction.

15. The energy storage apparatus according to claim 14, wherein the spacer includes the spacer protruding portion in a plurality such that the plurality of spacer protruding portions is arrayed in the third direction.

16. The energy storage apparatus according to claim 14, wherein the spacer protruding portion has a shape elongated in the second direction.

17. The energy storage apparatus according to claim 1, wherein the case includes a case protruding portion protruding in the first direction and positioned such that the case protruding portion is configured to restrict the movement of the spacer in the second direction.

18. The energy storage apparatus according to claim 1, wherein the spacer includes a first surface configured to be brought into contact with the case wall portion of the case body of the case and a second surface configured to be brought into contact with the energy storage device on an opposite side with respect to the first surface.

19. The energy storage apparatus according to claim 2, wherein the case protruding portion of the case and the spacer protruding portion of the spacer are formed such that a protruding amount of the case protruding portion in the first direction is smaller than a protruding amount of the spacer protruding portion in the first direction.

20. The energy storage apparatus according to claim 19, wherein the spacer includes a first surface configured to be brought into contact with the case wall portion of the case body of the case and a second surface configured to be brought into contact with the energy storage device on an opposite side with respect to the first surface.
